(19) United States
(12) Patent Application Publication
(10) Pub. No.: US 2005/0035114 A1
(43) Pub. Date: Feb. 17, 2005

(54) Flap it

(76) Inventors: Frank Fredrick Cron, Great Falls, MT (US); Marilyn Ann Cron, Great Falls, MT (US)

Correspondence Address: Frank and Marilyn Cron, 1401 3rd West Hill Drive, Great Falls, MT, 59404, US

(21) Appl. No.: 10/889,587

(22) Filed: Jul. 13, 2004

Related U.S. Application Data
(63) Continuation of application No. 60/495,146, filed on Aug. 15, 2003.

(51) Int. Cl. H05B 6/78

(52) U.S. Cl. 219/700

(57) ABSTRACT

The new product, Flap It, is unique in design, function, and compilation of household items for safe food handling as it protects food handlers during food placement and removal from the microwave; in addition it reduces excessive food spattering in the interior of the microwave. The thick paper product oven-mitt like air pocket textured cushioned sides offer protection against hot and/or cold products during placement and removal from the microwave. These textured sides are part of a sturdy support base that food items, with or without containers, are placed on. The sides of the paper product oven-mitt like air pocket textured portions are lined with vented parchment, wax, or plastic, or any combination of those, on the inside. This flap covers items during cooking thus reducing food spatters in the microwave interior so less time and fewer materials are spent on clean up.

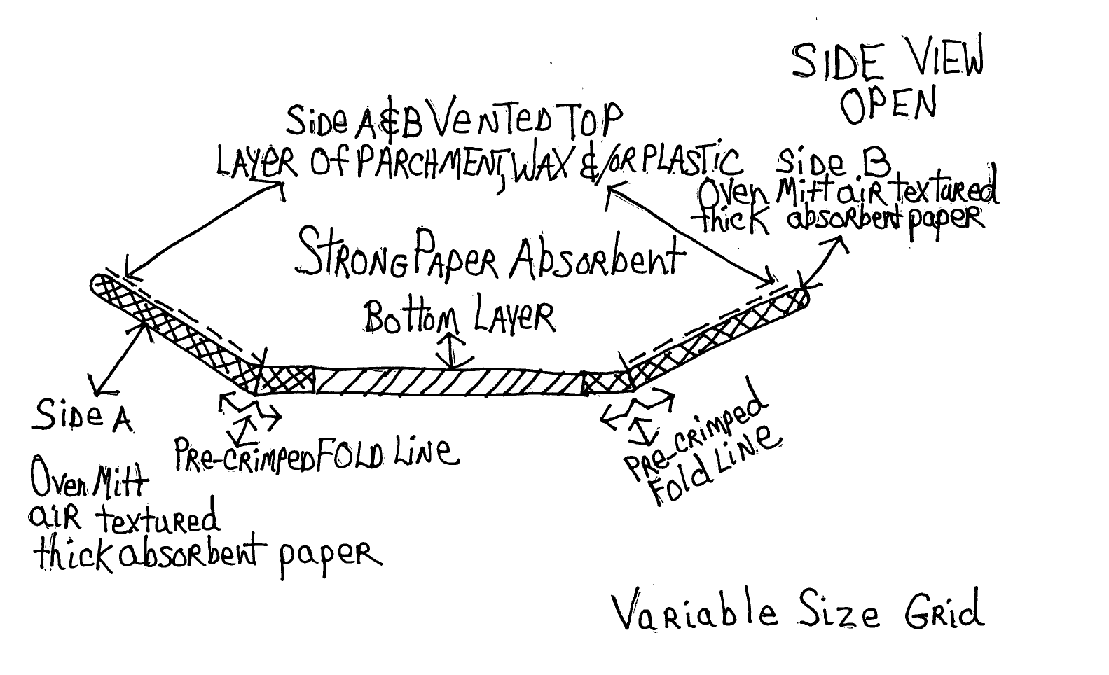

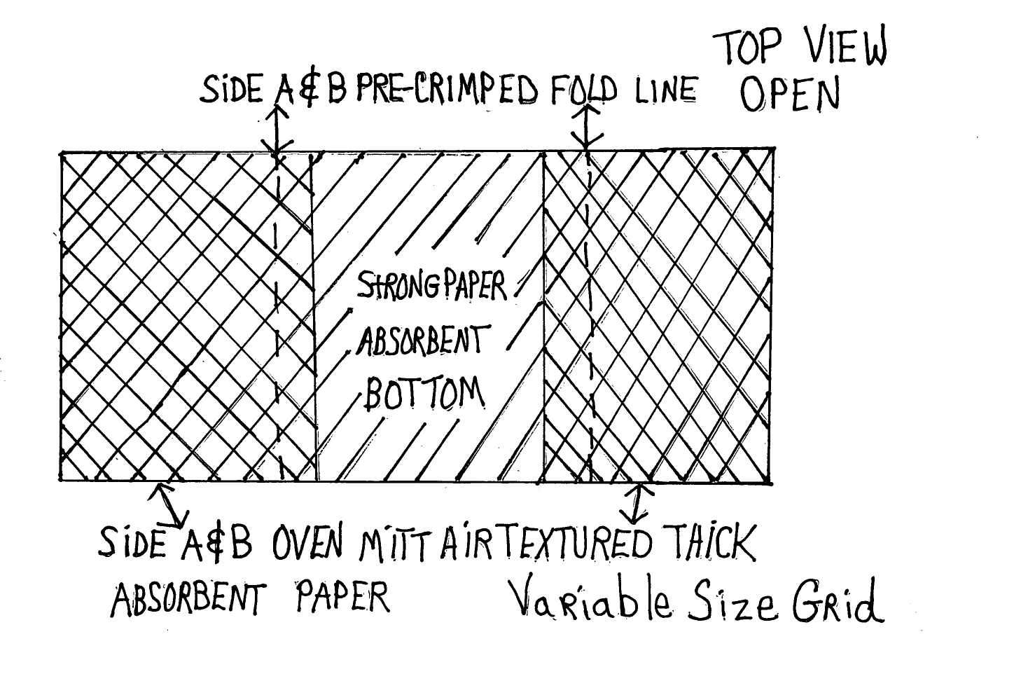

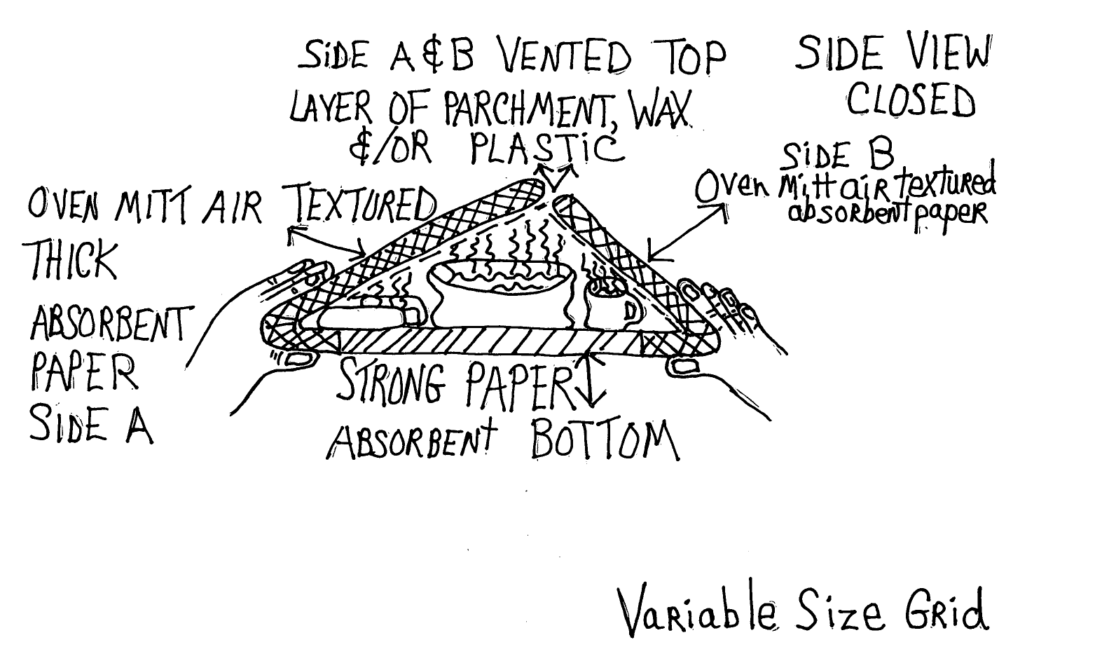

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The product, Flap It, is focused on the field of safe food handling while keeping cooking equipment from frequent spatters which thus reduces time and materials spent on cleaning. The Disclosure Document filed Aug. 4, 2003, number 535882; and the Provisional Patent Application No. 60/495,146 filed Aug. 15, 2003 are all related to this same product invention. This new use of common household products is focused on the specific problems of safe and clean food handling. The product covers food during microwave cooking time and reduces spatters. It contains two oven-mitt like air-pocket textured cushioned sides to assist the food handler in safely placing and removing items from the microwave by protecting hands. It would also be possible to utilize this product as a placemat and napkin after removal from microwave.

### BRIEF SUMMARY OF THE INVENTION

This compilation of common household products uses a new, unique idea to protect hands from touching food being placed and removed in the microwave, prevent heat/cold generated from food and containers from harming food handlers, and reduce the amount of time spent cleaning residue from the inside of the microwave. This compilation of common household products will assist any individual involved in cooking and cleaning in a household, or business setting where cooking occurs. The product, Flap It, can be folded over the top of items being cooked in the microwave creating a barrier to prevent spatters during cooking. Additionally this product provides two, textured oven-mitt like sides that protect the hands of the individual placing and removing items from the microwave.

### BRIEF DESCRIPTION OF THE SEVERAL VIEWS OF THE DRAWING

There are three drawings of the product; their statements correspond to the page numbers that are contained in each paragraph.

Drawing page 1 of the product, Flap It, shows an open cut away side view of the product. The size of the entire drawing is listed as variable so different sizes of the product may be manufactured to fit variable sizes of food and containers used in microwaves. This open cut away side view shows the pre-crimped fold line of the textured mitt portion of side A and side B that allows the interior surface of the mitt area to be folded over items being processed to reduce spatters. The drawing also shows the vented layer of parchment, wax, and/or plastic placed on the inside of the flap that covers items being cooked.

Drawing on page 2 of the product, Flap It, shows the birds eye top view of the product. The size of the entire drawing is listed as being a variable size grid. The purpose of the variable size grid is for manufacturing various sizes needed to cover variable sizes of food and containers being used by individuals. This drawing also shows the two quilted oven-mitt like air textured cushioned sides with the sturdy support bottom portion in the middle.

Drawing page 3 of the product, Flap It, shows the cut away side view of the product closed over sample food items. The items are representative of where food items and hands are placed for safe food handling. This representative drawing also shows how heat/cold and spatters are generated from items and how the quilted flap area protects against the generated heat/cold and spatters. Variable size grid statement is located at the bottom section of this drawing for considering the product will be needed in various sizes to allow for different sized containers and food items. The drawing also shows the vented area of parchment, wax, and/or plastic placed on the inside of the flap that covers items being cooked.

### DETAILED DESCRIPTION OF THE INVENTION

This new and unique product, Flap It, is a compilation of common household products; paper (recycled or new), and vented parchment, wax, or plastic, or a combination of any of those three, layered over the top of the inside of the paper oven-mitt like air pocket textured side areas. These common products will be compiled together as a new and unique combination in a manufacturing process that will layer a strong reinforced paper base with side areas of said paper base to an air pocket oven-mitt like textured side area additionally layered with vented parchment, wax, or plastic, or a combination of any of those three, that will allow this invention to be utilized as everyday safe food handling paraphernalia.

The product, Flap It, will be manufactured using a solid base of strong, absorbent paper layered on two sides with air pockets to create quilted oven-mitt like textured areas. The quilted areas on each side of the product will additionally be layered with one, or a combination of, the following household products that are vented; parchment, wax, or plastic placed on the inside flap to prevent spatters from collecting on the inside of the microwave during processing times.

This invention is an entirely new concept in the marketplace. Using the invention, Flap It, will follow a three step process for food handlers; (A) Food handler will pick the size of the product that best fits the food, with or without a container, being prepared for microwave processing, then (B) Food handler will lay the food item, with or without a container, in the center of the product and flap the quilted oven-mitt like textured air pocket sides loosely over the top of the food making sure the vented parchment, wax, or plastic compilation side is closest to the food, and then (C) Food handler will use the oven-mitt like textured air pocket sides to place hands on for placing and removing the food from the microwave.

1. “I(We) claim as our invention: a new concept for reducing cleaning time and materials used for cleaning of the interior of a microwave by reduction of food residue spatters created during cooking of food while providing for safer food handling while using our product.

2. “I(We) claim as our invention: a new concept in safe food handling using existing household products in a unique combination of:
strengthened paper products that are either recycled or new, combined with,
quilted oven-mitt like textured air pocket paper products that are either recycled or new, combined with,
a lining of vented parchment, wax, or plastic and/or any combination of those items layered on the inside flap of the oven-mitt like textured air pocket sides.

3. “I(We) claim as our invention: a new concept in safe food handling using a unique combination of household products to:
create an insulated barrier that supports and covers foods, with or without containers, during placement and removal from the microwave, while
protecting the food handlers from contact with unprocessed foods and/or containers, as well as providing,
protection for food handlers from contact with hot/cold foods and/or containers during placement and removal from the microwave, while
preventing food residue spatter build up on the interior of the microwave during food processing time.
